(19) United States
(12) Patent Application Publication
(10) Pub. No.: US 2019/0219879 A1
(43) Pub. Date: Jul. 18, 2019

(54) ACTIVE MATRIX TYPE DISPLAY DEVICE

(71) Applicant: SHARP KABUSHIKI KAISHA, Sakai City (JP)

(72) Inventor: MASAHIRO IMAI, Sakai City (JP)

(21) Appl. No.: 16/221,173

(22) Filed: Dec. 14, 2018

(30) Foreign Application Priority Data
Jan. 16, 2018 (JP) 2018-004663

(51) Int. Cl. G02F 1/1362; G09G 3/36

(52) U.S. Cl. CPC G02F 1/136286; G02F 2201/123; G09G 2320/0252; G09G 3/3648

(57) ABSTRACT

In an active matrix type display device, a display panel has a first number of source lines corresponding to each column of pixel circuits, the first number being equal to or larger than two, and a gate line drive circuit selects a first number of gate lines in a same period. At each of a part of connection positions between the source lines and the pixel circuits, the display panel has a connection unit including a first connection wiring formed in a same wiring layer as the gate line, having a first end connected to the source line, and extending in a same direction as the gate line to intersect with another source line in a planar view, and a second connection wiring formed in a same wiring layer as the source line, and connected to a second end of the first connection wiring. With this, a low-cost display device having a short screen update time is provided.

### BACKGROUND OF THE INVENTION

### Field of the Invention

The present invention relates to a display device, particularly to an active matrix type display device, such as an active matrix type liquid crystal display device.

### Description of Related Art

A liquid crystal display device is widely used as a thin, light-weight, and low-power consumption display device. An active matrix type liquid crystal display device includes a liquid crystal panel having a plurality of gate lines, a plurality of source lines, and a plurality of pixel circuits, a gate line drive circuit, and a source line drive circuit. The gate line is also called a scanning line, the source line is also called a data line, the gate line drive circuit is also called a scanning line drive circuit or a gate driver, and the source line drive circuit is also called a data line drive circuit or a source driver.

In a typical active matrix type liquid crystal display device, the gate line drive circuit selects one gate line in each horizontal period, and applies, to the selected gate line, a voltage with which a write control transistor in the pixel circuit turns on. The source line drive circuit applies voltages in accordance with a video signal to the plurality of source lines in each horizontal period. With this, the pixel circuits in one row are selected in each horizontal period, and the voltages in accordance with the video signal are written to the selected pixel circuits. A time from start of writing to finish of screen change (hereinafter referred to as a screen update time) in the liquid crystal display device is given as follows: (number of gate lines)×(length of horizontal period)+(response time of liquid crystal).

In order to prevent moving picture blur, some liquid crystal display devices each having a backlight perform an impulse drive in which the backlight turns on only in a turn-on period set in each frame period. In the liquid crystal display device performing the impulse drive, it is necessary to shorten the screen update time in order to finish response of liquid crystal before start of the turn-on period. Furthermore, a liquid crystal display device operating at a high frame rate, such as 90 Hz, 120 Hz, 240 Hz, is known in order to perform high quality display. Also in the liquid crystal display device operating at the high frame rate, it is necessary to shorten the screen update time in order to finish the response of the liquid crystal in a predetermined time.

As a method for shortening the screen update time, there is known a method in which a plurality of gate lines are selected in each horizontal period and voltages are written to the pixel circuits in a plurality of rows. For example, Japanese Laid-Open Patent Publication No. Hei 2-214818 discloses a liquid crystal display device in which one source line is provided on each side of a column of the pixel circuits and two gate lines are selected in a same period, and a liquid crystal display device in which two source lines are provided on each side of the column of the pixel circuits and four gate lines are selected in a same period. Japanese Laid-Open Patent Publication No. Hei 5-210089 discloses a liquid crystal display device in which two source lines are provided on one side of the column of the pixel circuits and two gate lines are selected in a same period.

In the active matrix type liquid crystal display device, in order to write voltages to the pixel circuits in a plurality of rows, it is necessary to provide a plurality of source lines corresponding to the column of the pixel circuits and connect the source lines and the pixel circuits at predetermined positions. When no other source line exists between the source line and the pixel circuit, the source line and the pixel circuit can be connected easily by branching the source line. However, when another source line exists between the source line and the pixel circuit, it is necessary to connect the source line and the pixel circuit without connecting to the other source line. For this purpose, it is necessary to provide a wiring (hereinafter referred to as a connection wiring) for connecting the source line and the pixel circuit with avoiding the other source line.

Japanese Laid-Open Patent Publication No. Hei 2-214818 does not specifically disclose what kind of connection wiring is provided when another source line exists between the source line and the pixel circuit. Japanese Laid-Open Patent Publication No. Hei 5-210089 discloses forming the gate line, the source line, and the connection wiring in different wiring layers. However, if a liquid crystal panel having three wiring layers is used, cost of the liquid crystal display device is increased. A similar problem occurs in an active matrix type display device other than the active matrix type liquid crystal display device.

### SUMMARY OF THE INVENTION

Therefore, providing a low-cost display device having a short screen update time is taken as a problem.

The above-described problem can be solved by an active matrix type display device comprising: a display panel including a plurality of gate lines extending in a row direction, a plurality of source lines extending in a column direction, and a plurality of pixel circuits arranged in the row direction and the column direction; a gate line drive circuit configured to drive the gate lines; and a source line drive circuit configured to drive the source lines, wherein the source lines are provided so that a first number of source lines correspond to each column of the pixel circuits, the first number being equal to or larger than two, the gate line drive circuit is configured to select a first number of gate lines in a same period, and the display panel has a connection unit including a first connection wiring formed in a same wiring layer as the gate line, having a first end connected to the source line, and extending in the row direction to intersect with another source line in a planar view, and a second connection wiring formed in a same wiring layer as the source line, and connected to a second end of the first connection wiring, at each of a part of connection positions between the source lines and the pixel circuits.

According to the above-described display device, it is possible to shorten a screen update time (time from start of writing to finish of screen change) by selecting a plurality of gate lines in a same period and writing to the pixel circuits in a plurality of rows in the same period. Furthermore, since the connection unit including the first connection wiring formed in the same layer as the gate line and the second connection wiring formed in the same layer as the source line is used when connecting the source line and the pixel circuit, a display panel having two wiring layers can be used. Therefore, a low-cost display device having a short screen update time can be provided.

These and other objects, features, modes and effects of the present invention will be more apparent from the following detailed description with reference to the attached drawings.

### BRIEF DESCRIPTION OF THE DRAWINGS

FIG. 1 is a block diagram showing a configuration of a liquid crystal display device according to a first embodiment.

FIG. 2 is an equivalent circuit diagram of a liquid crystal panel of the liquid crystal display device shown in FIG. 1.

FIG. 3 is a layout diagram of the liquid crystal panel shown in FIG. 2.

FIG. 4 is a cross sectional view taken along line A-A′ in FIG. 3.

FIG. 5 is a timing chart of a liquid crystal display device according to a comparative example.

FIG. 6 is a timing chart of the liquid crystal display device shown in FIG. 1.

FIG. 7 is a block diagram showing a configuration of a source line drive circuit of a liquid crystal display device according to a second embodiment.

FIG. 8 is a diagram showing a connection form between a liquid crystal panel and the source line drive circuit in the liquid crystal display device according to the second embodiment.

FIG. 9 is an equivalent circuit diagram of a liquid crystal panel of a liquid crystal display device according to a third embodiment.

FIG. 10 is a block diagram showing a configuration of a liquid crystal display device according to a fourth embodiment.

FIG. 11 is a diagram showing an equivalent circuit of a liquid crystal panel and a connection form between the liquid crystal panel and a source line drive circuit in the liquid crystal display device shown in FIG. 10.

### DETAILED DESCRIPTION OF THE INVENTION

### First Embodiment

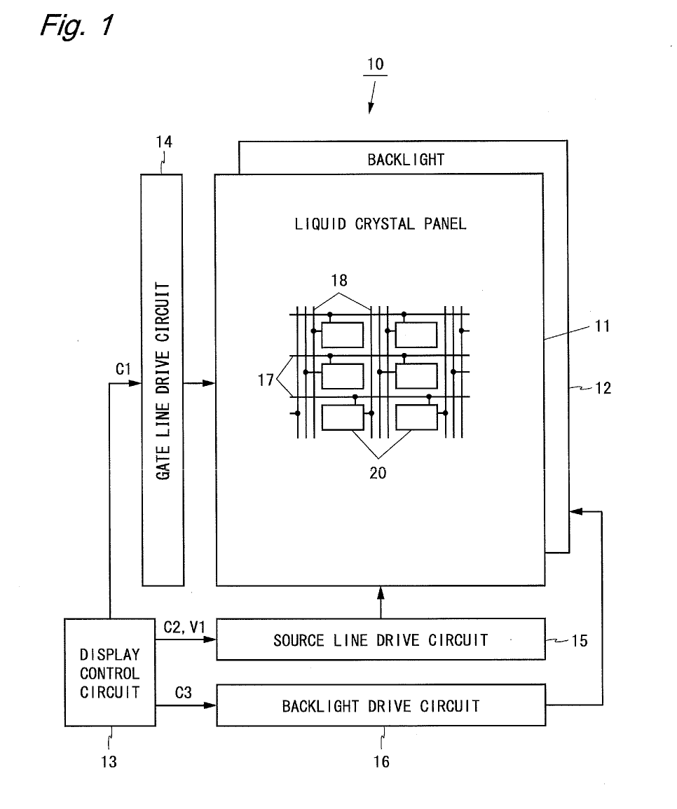

FIG. 1 is a block diagram showing a configuration of a liquid crystal display device according to a first embodiment. A liquid crystal display device 10 shown in FIG. 1 is an active matrix type liquid crystal display device including a liquid crystal panel 11, a backlight 12, a display control circuit 13, a gate line drive circuit 14, a source line drive circuit 15, and a backlight drive circuit 16. Hereinafter, it is assumed that m and p are integers equal to or larger than two, and n is a multiple of p. Note that n is assumed to be a multiple of p for convenience of description here, n is not necessarily a multiple of p in general.

The liquid crystal panel 11 includes n gate lines 17, (m×p) source lines 18, and (n×m) pixel circuit 20. The n gate lines 17 are arranged in parallel with each other. The (m×p) source lines 18 are arranged in parallel with each other so as to intersect with the n gate lines 17 perpendicularly. Hereinafter, an extending direction of the gate line 17 (horizontal direction in the drawings) is referred to as a row direction, and an extending direction of the source line 18 (vertical direction in the drawings) is referred to as a column direction. The (n×m) pixel circuits 20 are arranged two-dimensionally in the row direction and the column direction. A number of rows of the pixel circuits 20 is n, and a number of columns of the pixel circuits 20 is m. The (m×p) source lines 18 are provided so that p source lines correspond to each column of the pixel circuits 20.

The display control circuit 13 outputs a control signal C1 to the gate line drive circuit 14, outputs a control signal C2 and a video signal V1 to the source line drive circuit 15, and outputs a control signal C3 to the backlight drive circuit 16. For example, the control signal C1 includes a gate start pulse and a gate clock, the control signal C2 includes a source start pulse and a source clock, and the control signal C3 includes a turn-on control signal of the backlight 12.

The gate line drive circuit 14 drives the n gate lines 17 based on the control signal C1. The source line drive circuit 15 drives the (m×p) source lines 18 based on the control signal C2 and the video signal V1. The backlight drive circuit 16 drives the backlight 12 based on the control signal C3. The backlight 12 is disposed on a back surface side of the liquid crystal panel 11 and irradiates a back surface of the liquid crystal panel 11 with light.

In the liquid crystal display device 10, (n/p) horizontal periods are set in one frame period. The n gate lines 17 are classified into (n/p) groups, each including p gate lines. One ends of the p gate lines included in each group are connected to a same node. (N/p) nodes are connected to (n/p) output terminals of the gate line drive circuit 14, respectively.

Note that it is enough that the gate line drive circuit 14 has at least (n/p) output terminals. For example, if the gate line drive circuit 14 has n output terminals, the (n/p) nodes may be connected to every p output terminals of the gate line drive circuit 14. The gate line drive circuit 14 performs a same operation with respect to every p output terminals, and realizes a same state realized by a gate line drive circuit having (n/p) output terminals. Furthermore, for example, if p is even and the gate line drive circuit 14 has (n/2) output terminals, the (n/p) nodes may be connected to every (p/2) output terminals of the gate line drive circuit 14. In this case, the gate line drive circuit 14 performs a same operation with respect to every (p/2) output terminals, and realizes the same state realized by the gate line drive circuit having (n/p) output terminals.

The gate line drive circuit 14 outputs a high-level voltage from one output terminal and outputs a low-level voltage from remaining output terminals, based on the control signal C1 in each horizontal period. With this, the gate line drive circuit 14 selects p gate lines 17 included in one group in a same horizontal period. In each horizontal period, (m×p) pixel circuits 20 corresponding to the p gate lines 17 are selected. The source line drive circuit 15 applies (m×p) voltages in accordance with the video signal V1, to the (m×p) source lines 18 based on the control signal C2 in each horizontal period. With this, the (m×p) voltages in accordance with the video signal V1 are written to the selected (m×p) pixel circuits 20, respectively.

A turn-on period of the backlight 12 is set in a vertical flyback period within one frame period. The turn-on control signal included in the control signal C3 becomes a high level in the turn-on period, and becomes a low level otherwise. The backlight 12 turns on when the turn-on control signal is in the high level, and turns off when the turn-on control signal is in the low level. In this manner, the liquid crystal display device 10 performs an impulse drive in which the backlight 12 turns on only in the turn-on period set in each frame period. Moving picture blur can be reduced by performing the impulse drive.

In the liquid crystal panel 11, the source lines 18 and the pixel circuits 20 are connected at predetermined positions. If no other source line 18 exists between the source line 18 and the pixel circuit 20, a branching portion is provided to the source line 18 and the branching portion of the source line 18 and the pixel circuit 20 are connected. If another source line 18 exists between the source line 18 and the pixel circuit 20, a connection unit (detail will be described later) for connecting the source line 18 and the pixel circuit 20 with avoiding the other source line 18 is provided to a connection position between the source line 18 and the pixel circuit 20. The liquid crystal panel 11 has the connection unit at each of a part of the connection positions between the source lines 18 and the pixel circuits 20. A case where p=3 is described below.

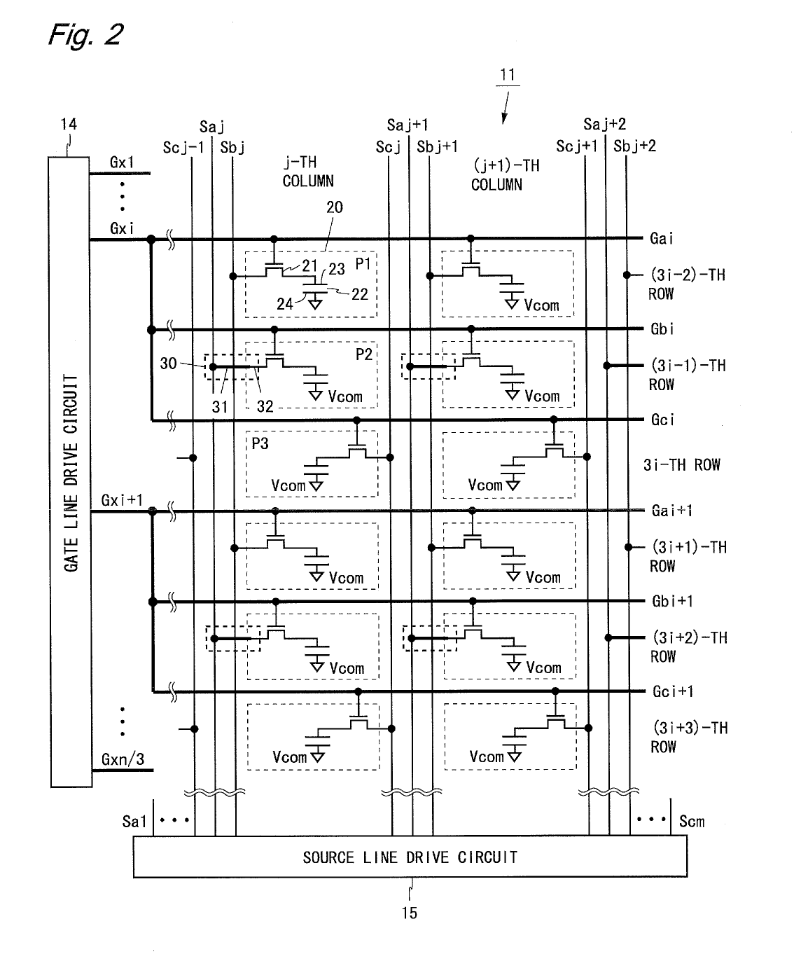

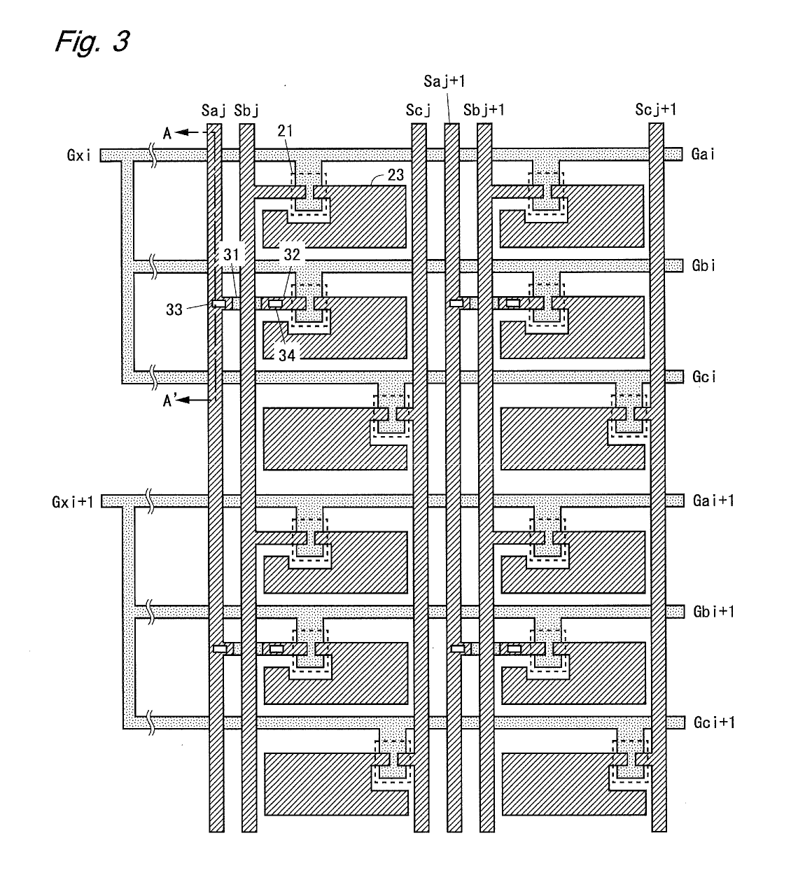

FIG. 2 is an equivalent circuit diagram of the liquid crystal panel 11. FIG. 3 is a layout diagram of the liquid crystal panel 11. The liquid crystal panel 11 has two wiring layers. A lower layer is a gate wiring layer, and an upper layer is a source wiring layer. In the equivalent circuit diagram of the liquid crystal panel, a thick line represents a wiring formed in the gate wiring layer, and other wirings represent wirings formed in the source wiring layer. A rectangle with thin broken lines represents the pixel circuit, and a rectangle with broken lines represents the connection unit. In FIG. 3, a dot pattern portion represents a pattern of the gate wiring layer, an oblique line portion represents a pattern of the source wiring layer, and a rectangle with broken lines represents a TFT (Thin Film Transistor).

The pixel circuit 20 includes a TFT 21 and a liquid crystal capacitance 22. The liquid crystal capacitance 22 has a pixel electrode 23 and a common electrode 24. The pixel circuit 20 is connected to one gate line 17 and one source line 18. A gate terminal of the TFT 21 is connected to the gate line 17, and a source terminal of the TFT 21 is connected to the source line 18. A drain terminal of the TFT 21 is connected to the pixel electrode 23, and a common electrode voltage Vcom is applied to the common electrode 24. The TFT 21 functions as a write control transistor.

FIGS. 2 and 3 describe twelve pixel circuits 20 arranged in (3i−2)-th to (3i+3)-th rows and j-th to (j+1)-th columns. The liquid crystal panel 11 has a repeating structure in which the pixel circuits 20 in three rows and one column form a unit. Here, the pixel circuits 20 in the (3i−2)-th to 3i-th rows and the j-th column are respectively referred to as P1 to P3, and the pixel circuits P1 to P3 and wirings connected to the pixel circuits P1 to P3 are described. Other portions of the liquid crystal panel 11 have a similar configuration.

Gate lines Gai to Gci are respectively arranged on upper sides (upper sides in the drawings) of the pixel circuits P1 to P3. Source lines Saj, Sbj are arranged on a left side of the pixel circuits P1 to P3, and a source line Scj is arranged on a right side of the pixel circuits P1 to P3. The gate lines Gai to Gci are classified into a same group, and one ends (left ends in the drawings) of the gate lines Gai to Gci are connected to a same node. The node is connected to an i-th output terminal of the gate line drive circuit 14 using a wiring Gxi. The gate line drive circuit 14 selects the gate lines Gai to Gci in a same period by applying a voltage with which the TFT 21 turns on, to the node connected to the wiring Gxi. One ends (lower ends in the drawings) of the source lines Saj to Scj are connected to the source line drive circuit 15.

The gate lines Gai to Gci and the wiring Gxi are formed in the gate wiring layer integrally. The source lines Saj to Scj and the pixel electrodes 23 in the pixel circuits P1 to P3 are formed in the source wiring layer separately. The pixel circuit P1 is connected to the gate line Gai and the source line Sbj, the pixel circuit P2 is connected to the gate line Gbi and the source line Saj, and the pixel circuit P3 is connected to the gate line Gci and the source line Scj.

The gate line Gai has a branching portion (a portion branching to a lower direction in the drawings) corresponding to the pixel circuit P1. Since no other gate line exists between the gate line Gai and the pixel circuit P1, the gate line Gai and the pixel circuit P1 can be connected easily by branching the gate line Gai. By a similar method, the gate line Gbi and the pixel circuit P2 are connected, and the gate line Gci and the pixel circuit P3 are connected.

The source line Sbj has a branching portion (a portion branching to a right direction in the drawings) corresponding to the pixel circuit P1. Since no other source line exists between the source line Sbj and the pixel circuit P1, the source line Sbj and the pixel circuit P1 can be connected easily by branching the source line Sbj. By a similar method, the source line Scj and the pixel circuit P3 are connected.

The source line Sbj exists between the source line Saj and the pixel circuit P2. In order to connect the source line Saj and the pixel circuit P2 with avoiding the source line Sbj, a connection unit 30 is provided to the liquid crystal panel 11. The connection unit 30 includes two connection wirings 31, 32 and two contact holes 33, 34. The connection wiring 31 is formed in the gate wiring layer, has one end (left end in the drawings) connected to the source line Saj, and extends in the row direction to intersect with the source line Sbj in a planar view. The connection wiring 32 is formed in the source wiring layer, has one end (left end in the drawings) connected to the other end of the connection wiring 31, and extends in the row direction. The contact hole 33 connects the source line Saj and the one end of the connection wiring 31. The contact hole 34 connects the other end of the connection wiring 31 and one end of the connection wiring 32.

The pixel electrodes 23 of the pixel circuits P1, P3 have portions (portions depicted in rectangles with broken lines in FIG. 3) opposing to the branching portions of the source lines Sbj, Scj, respectively. The pixel electrode 23 of the pixel circuit P2 has a portion opposing to the other end of the connection wiring 32. In a lower layer (gate wiring layer) where two members oppose in the pixel circuits P1 to P3, the branching portions of the gate lines Gai to Gci exist, respectively. With this, the TFTs 21 are formed at positions shown by the broken lines in FIG. 3. Ends of the branching portions of the gate lines Gai to Gci function as gate terminals of the TFTs 21. Ends of the branching portions of the source lines Sbj, Scj and the other end (right end in the drawings) of the connection wiring 32 function as source terminals of the TFTs 21. A part of the pixel electrode 23 functions as a drain electrode of the TFT 21.

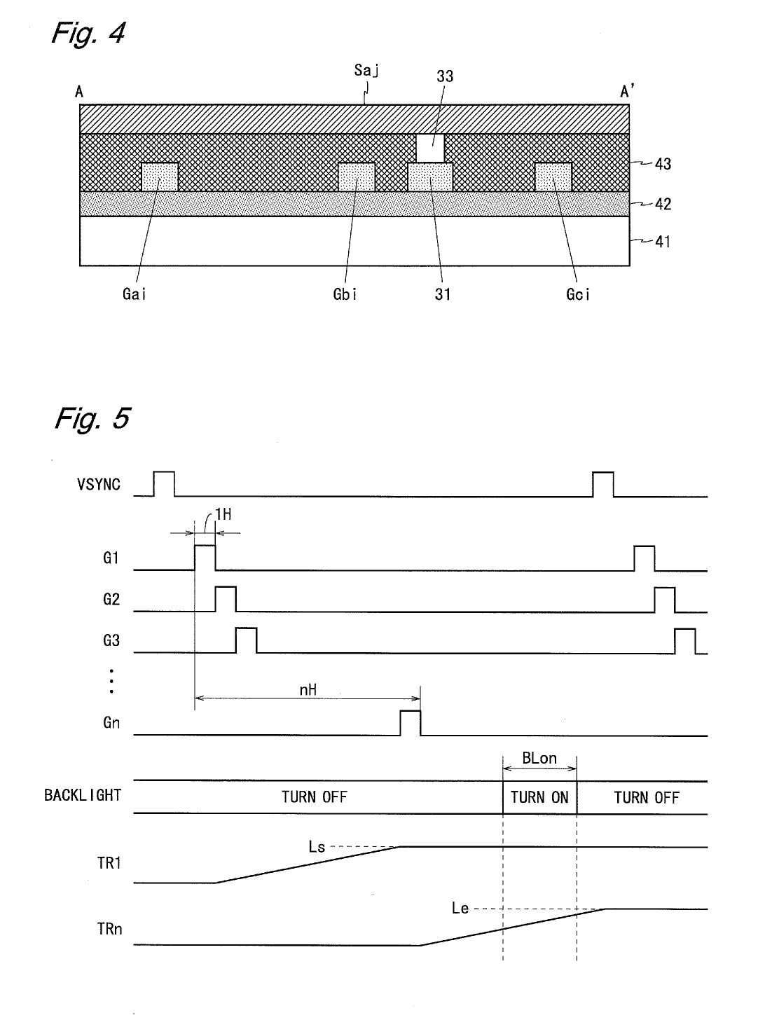

FIG. 4 is a cross sectional view taken along line A-A′ in FIG. 3. In FIG. 4, two wiring layers are formed on a grass substrate 41 to which a base coat 42 is applied, with an insulating layer 43 interposed therebetween. The gate lines Gai to Gci and the connection wiring 31 are formed in the gate wiring layer, and the source line Saj is formed in the source wiring layer. The contact hole 33 penetrating the insulating layer 43 is formed on the connection wiring 31. The source line Saj and the connection wiring 31 are connected using the contact hole 33.

In this manner, in the liquid crystal panel 11, first and second source lines (source lines Saj, Sbj) are arranged on a first side (left side) of the pixel circuit 20 in an descending order of distance from the pixel circuit 20, and a third source line (source line Scj) is arranged on a second side (right side) of the pixel circuit 20. The connection unit 30 connects the pixel circuit 20 and the first source line with avoiding the second source line. The pixel circuits 20 in a same row are connected to one of the first to third source lines. The source line 18 to which the pixel circuits 20 in a same column are connected is changed periodically among the first to third source lines (is changed in an order of source lines Sbj, Saj, Scj).

When each of the source lines Sbj, Scj including its branching portion is considered as one wiring and the source line Saj including the connection unit 30 is considered as one wiring, a resistance of the source line Saj is larger than resistances of the source lines Sbj, Scj unless any special contrivance is adopted. When a resistance difference between the source lines is large, brightness unevenness may occur in a display screen. Thus, in the liquid crystal display device 10, a line width of the source line Saj may be wider than line widths of the source lines Sbj, Scj. With this, it is possible to reduce the resistance difference between the source lines and reduce the brightness unevenness which occurs in the display screen.

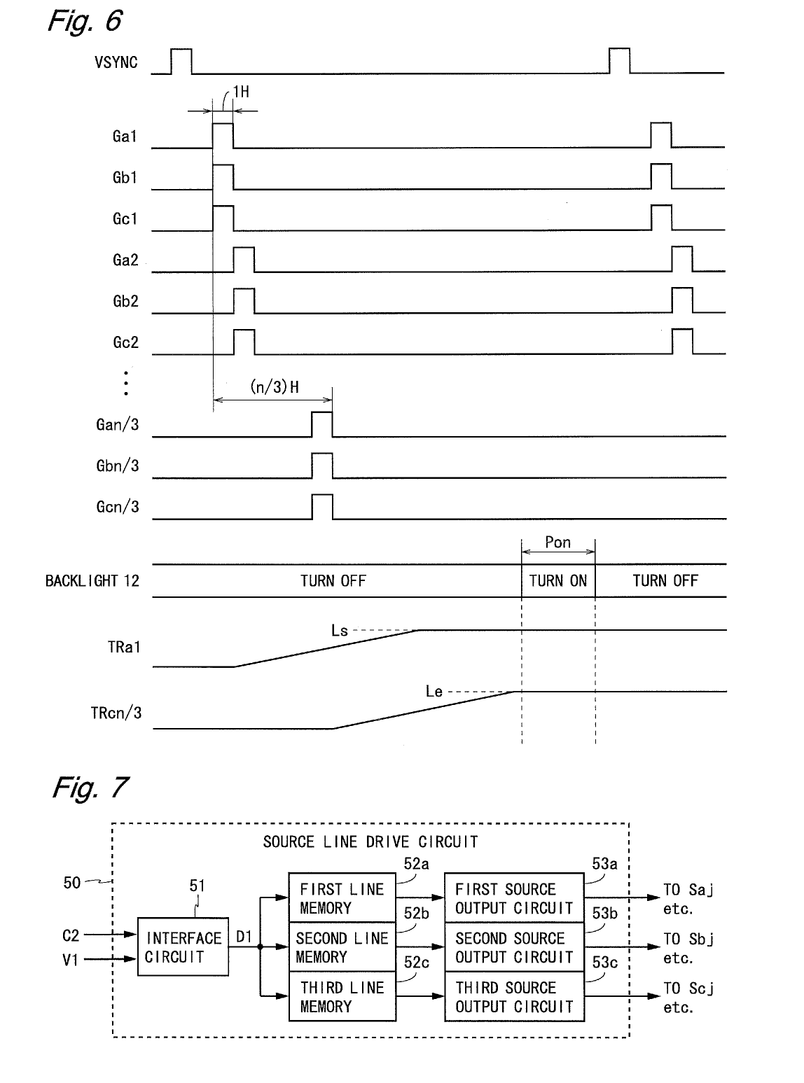

As a liquid crystal display device according to a comparative example, consider a liquid crystal display device including a liquid crystal panel having n gate lines, m source lines, and (n×m) pixel circuits, and performing the impulse drive. FIG. 5 is a timing chart of the liquid crystal display device according to the comparative example. FIG. 6 is a timing chart of the liquid crystal display device 10. In FIGS. 5 and 6, H represents a horizontal period, BLon represents a turn-on period of the backlight, and TR* (* is an arbitrary character string) represents transmittance of the pixel circuit connected to a gate line G*.

In the liquid crystal display device according to the comparative example (FIG. 5), n horizontal periods are set in one frame period, and the gate line drive circuit selects one gate line in each horizontal period. In a first horizontal period, a voltage of a gate line G1 becomes the high level, and voltages are written to the pixel circuits connected to the gate line G1. Transmittance TR1 of the pixel circuit connected to the gate line G1 is changed toward a level Ls in and after the first horizontal period. In an n-th horizontal period, a voltage of a gate line Gn becomes the high level, and voltages are written to the pixel circuits connected to the gate line Gn. Transmittance TRn of the pixel circuit connected to the gate line Gn is changed toward a level Le in and after the n-th horizontal period. The backlight turns on only in the turn-on period BLon.

In the example shown in FIG. 5, the transmittance TR1 of the pixel circuit connected to the gate line G1 already reaches the level Ls before start of the turn-on period BLon. However, the transmittance TRn of the pixel circuit connected to the gate line Gn does not reach the level Le before the start of the turn-on period BLon. In the liquid crystal display device according to the comparative example, since a response of liquid crystal is not in time, brightness of a portion which is changed later in the display screen may not reach a desired level before the start of the turn-on period BLon. If the impulse drive is performed in a case where the response of the liquid crystal is not in time, although correct display can be performed in a portion which is changed earlier in the display screen, correct display can not be performed in a portion which is changed later in the display screen.

In the liquid crystal display device 10 (FIG. 6), (n/p) horizontal periods are set in one frame period and the gate line drive circuit 14 selects p gate lines in each horizontal period. Thus, a voltage writing period (period for writing to all pixel circuits) of the liquid crystal display device 10 is reduced to 1/p of a voltage writing period of the liquid crystal display device according to the comparative example.

In the example shown in FIG. 6, transmittance TRa1 of the pixel circuit 20 connected to a gate line Ga1 already reaches the level Ls before the start of the turn-on period BLon. Furthermore, since the voltage writing period is short, transmittance TRcn/3 of the pixel circuit 20 connected to a gate line Gcn/3 also reaches the level Le before the start of the turn-on period BLon. In this manner, in the liquid crystal display device 10, since the response of the liquid crystal is in time, not only brightness in a portion which is changed earlier in the display screen but also brightness in a portion which is changed later in the display screen already reaches a desired level before the start of the turn-on period BLon. Therefore, according to the liquid crystal display device 10 according to the present embodiment, it is possible to display with a correct brightness in all over the display screen with reducing moving picture blur.

As described above, in the liquid crystal display device 10 according to the present embodiment, the source lines 18 are provided so that a first number of source lines correspond to each column of the pixel circuits 20 (p lines for each column), the first number being equal to or larger than two, and the gate line drive circuit 14 selects the first number of gate lines 17 (p gate lines) in a same period. The display panel (liquid crystal panel 11) has the connection unit 30 including a first connection wiring (connection wiring 31) formed in a same wiring layer as the gate line 17, having a first end connected to the source line 18, and extending in the row direction to intersect with another source line 18 in the planar view, and a second connection wiring (connection wiring 32) formed in a same wiring layer as the source line 18, and connected to a second end of the first connection wiring, at each of a part of connection positions between the source lines 18 and the pixel circuits 20.

According to the liquid crystal display device 10, it is possible to shorten a screen update time (time from start of writing to finish of screen change) by selecting a plurality of gate lines 17 in a same period and writing to the pixel circuits 20 in a plurality of rows in the same period. Furthermore, since the connection unit 30 including the first connection wiring formed in the same wiring layer as the gate line 17 and the second connection wiring formed in the same wiring layer as the source line 18 are used for connecting the source line 18 and the pixel circuit 20, a display panel (liquid crystal panel 11) with two wiring layers can be used. Therefore, a low-cost liquid crystal display device having a short screen update time can be provided.

The connection unit 30 includes a first contact hole (contact hole 33) for connecting the source line 18 and the first end of the first connection wiring, and a second contact hole (contact hole 34) for connecting the second end of the first connection wiring and the second connection wiring. The second connection wiring extends in the row direction, and the second contact hole connects the second end of the first connection wiring and a first end of the second connection wiring. By using such two contact holes, it is possible to configure the connection unit for connecting the source line 18 and the pixel circuit 20 with avoiding the other source line 18. The pixel circuit 20 includes a write control transistor (TFT 21), and a second end of the second connection wiring functions as one conduction terminal (source terminal) of the write control transistor. The write control transistor can be configured using such a second connection wiring. One ends of the first number of gate lines 17 are connected to a same node, and the gate line drive circuit 14 applies a voltage to the node. With this, the first number of gate lines 17 can be selected easily in a same period.

The liquid crystal display device 10 includes the backlight 12 and the backlight drive circuit 16 for turning on the backlight 12 only in the turn-on period BLon set in one frame period. Change of transmittance of the pixel circuit 20 to which a voltage is written last in one frame period finishes before the start of the turn-on period BLon. Therefore, it is possible to display with a correct brightness in all over the display screen with preventing moving picture blur.

Note that an active matrix type liquid crystal display device which does not perform the impulse drive and operates at a frame rate higher than 60 Hz (for example, 90 Hz, 120 Hz, 240 Hz) maybe configured as a variant of the first embodiment. According to the active matrix type liquid crystal display device according to the variant, it is possible to further finish the response of the liquid crystal in a predetermined time and perform high quality display.

### Second Embodiment

A liquid crystal display device according to a second embodiment has a configuration in which the source line drive circuit 15 is replaced with a source line drive circuit shown below in the liquid crystal display device 10 according to the first embodiment. In each embodiment shown below, differences from the first embodiment will be described. It is assumed that p=3 also in the present embodiment.

FIG. 7 is a block diagram showing a configuration of a source line drive circuit of the liquid crystal display device according to the present embodiment. A source line drive circuit 50 shown in FIG. 7 includes an interface circuit 51, first to third line memories 52a to 52c, and first to third source output circuits 53a to 53c. The first to third line memories 52a to 52c correspond to the first to third source output circuits 53a to 53c, respectively. The first to third source output circuits 53a to 53c have a same configuration and operate in parallel.

The interface circuit 51 receives the control signal C2 and the video signal V1 output from the display control circuit 13, and extracts display data D1 from the video signal V1. The display data D1 is written to one of the first to third line memories 52a to 52c in accordance with a position in the display screen. The first source output circuit 53a respectively applies, to m source lines Sa1 to Sam, m voltages in accordance with display data stored in the first line memory 52a. The second source output circuit 53b respectively applies, to m source lines Sb1 to Sbm, m voltages in accordance with display data stored in the second line memory 52b. The third source output circuit 53c respectively applies, to m source lines Sc1 to Scm, m voltages in accordance with display data stored in the third line memory 52c.

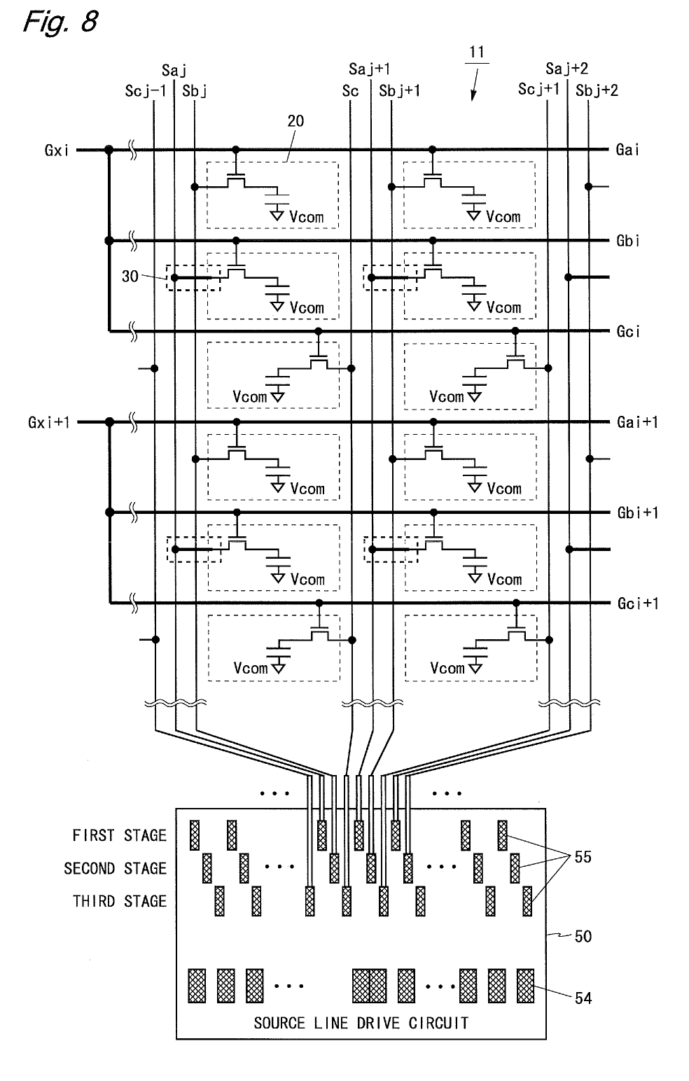

FIG. 8 is a diagram showing a connection form between the liquid crystal panel 11 and the source line drive circuit 50 in the liquid crystal display device according to the present embodiment. As shown in FIG. 8, an IC chip including the source line drive circuit 50 has a plurality of input terminals 54 and 3m output terminals 55. These terminals have a protruding form and are provided to a back surface of the IC chip (such terminals are called bumps). The 3m output terminals 55 are arranged in a three-stage staggered manner. The output terminals 55 connected to source lines Saj, Saj+1, and the like are arranged in a first stage of a staggered array. The output terminals 55 connected to source lines Sbj, Sbj+1, and the like are arranged in a second stage of the staggered array. The output terminals 55 connected to source lines Scj, Scj+1, and the like are arranged in a third stage of the staggered array.

In the liquid crystal display device according to the present embodiment, the source line drive circuit 50 includes a first number of line memories (p line memories 52), the first number being equal to or larger than two, and a first number of output circuits (p source output circuits 53) having a same configuration and operating in parallel. According to the liquid crystal display device according to the present embodiment, it is possible to design the source line drive circuit 50 easily by dividing the source line drive circuit 50 into a plurality of portions, and enhance a layout efficiency of the source line drive circuit 50.

### Third Embodiment

A liquid crystal display device according to a third embodiment has a configuration in which the liquid crystal panel 11 is replaced with a liquid crystal panel shown below in the liquid crystal display device 10 according to the first embodiment. It is assumed that p=3 also in the present embodiment.

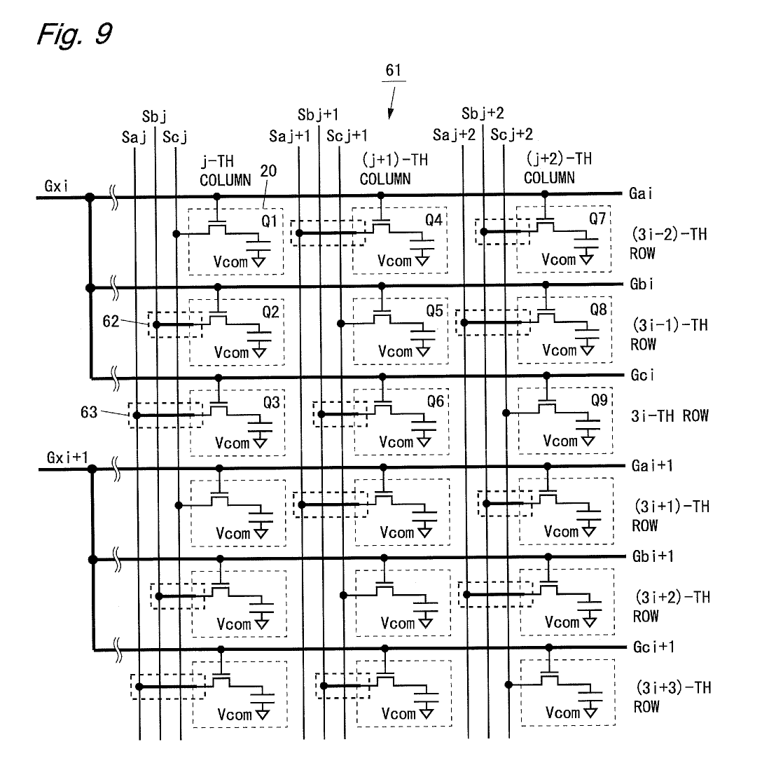

FIG. 9 is an equivalent circuit diagram of a liquid crystal panel 61 of the liquid crystal display device according to the present embodiment. FIG. 9 describes eighteen pixel circuits 20 arranged in (3i−2)-th to (3i+3)-th rows and j-th to (j+2)-th columns. The liquid crystal panel 61 has a repeating structure in which the pixel circuits 20 in three rows and three columns form a unit. Here, the pixel circuits 20 in the (3i−2)-th to 3i-th rows and the j-th column are referred to as Q1 to Q3, the pixel circuits 20 in the (3i−2)-th to 3i-th rows and the (j+1)-th column are referred to as Q4 to Q6, the pixel circuits 20 in the (3i−2)-th to 3i-th rows and the (j+2)-th column are referred to as Q7 to Q9, and the pixel circuits Q1 to Q9 and wirings connected to the pixel circuits Q1 to Q9 are described. Other portions of the liquid crystal panel 61 have a similar configuration.

Gate lines Gai to Gci are respectively arranged on an upper side of the pixel circuits Q1, Q4, Q7, an upper side of the pixel circuits Q2, Q5, Q8, and an upper side of the pixel circuits Q3, Q6, Q9. Source lines Saj to Scj are arranged on a left side of the pixel circuits Q1 to Q3, source lines Saj+1 to Scj+1 are arranged on a left side of the pixel circuits Q4 to Q6, and source lines Saj+2 to Scj+2 are arranged on a left side of the pixel circuits Q7 to Q9. The gate lines Gai to Gci are classified into a same group, and one ends of the gate lines Gai to Gci are connected to a same node. The node is connected to the i-th output terminal of the gate line drive circuit 14 using the wiring Gxi. One ends of the source lines Saj to Scj, Saj+1 to Scj+1, Saj+2 to Scj+2 are connected to the source line drive circuit 15.

The gate lines Gai to Gci and the wiring Gxi are formed in the gate wiring layer integrally. The source lines Saj to Scj, Saj+1 to Scj+1, Saj+2 to Scj+2 and the pixel electrodes 23 in the pixel circuits Q1 to Q9 are formed in the source wiring layer separately. The pixel circuits Q1 to Q3 are connected to the gate line Gai, the pixel circuits Q4 to Q6 are connected to the gate line Gbi, and the pixel circuits Q7 to Q9 are connected to the gate line Gci. The pixel circuits Q1 to Q9 are connected to the source lines Scj, Sbj, Saj, Saj+1, Scj+1, Sbj+1, Sbj+2, Saj+2, Scj+2, respectively.

The gate line Gai has branching portions corresponding to the pixel circuits Q1, Q4, Q7. Since no other gate line exists between the gate line Gai and the pixel circuits Q1, Q4, Q7, the gate line Gai and the pixel circuits Q1, Q4, Q7 can be connected easily by branching the gate line Gai. By a similar method, the gate line Gbi and the pixel circuits Q2, Q5, Q8 are connected, and the gate line Gci and the pixel circuits Q3, Q6, Q9 are connected.

The source line Scj has a branching portion corresponding to the pixel circuit Q1. Since no other source line exists between the source line Scj and the pixel circuit Q1, the source line Scj and the pixel circuit Q1 can be connected easily by branching the source line Scj. By a similar method, the source line Scj+1 and the pixel circuit Q5 are connected, and the source line Scj+2 and the pixel circuit Q9 are connected.

The source line Scj exists between the source line Sbj and the pixel circuit Q2. In order to connect the source line Sbj and the pixel circuit Q2 with avoiding the source line Scj, a connection unit 62 having a same configuration as the connection unit 30 according to the first embodiment is provided to the liquid crystal panel 61. By a similar method, the source line Sbj+1 and the pixel circuit Q6 are connected, and the source line Sbj+2 and the pixel circuit Q7 are connected.

The source lines Sbj, Scj exist between the source line Saj and the pixel circuit Q3. In order to connect the source line Saj and the pixel circuit Q3 with avoiding the source lines Sbj, Scj, a connection unit 63 having the same configuration as the connection unit 30 is provided to the liquid crystal panel 61. However, the connection wiring formed in the gate wiring layer intersect not only with the source line Scj but also with the source line Sbj in the planar view. By a similar method, the source line Saj+1 and the pixel circuit Q4 are connected, and the source line Saj+2 and the pixel circuit Q8 are connected.

In the liquid crystal panel 61, first, second, and third source lines (source lines Saj to Scj) are arranged on a first side (left side) of the pixel circuit 20 in a descending order of distance from the pixel circuit 20. Each of a part of the connection units 62 connects the second source line and the pixel circuit 20 with avoiding the third source line. Each of remaining connection units 63 connects the first source line and the pixel circuit 20 with avoiding the second and third source lines. The source line to which the pixel circuits 20 in a same row are connected is changed periodically among the first to third source lines (is changed in an order of source lines Scj, Sbj, Saj). The source line to which the pixel circuits 20 in a same column are connected is changed periodically among the first to third source lines (is changed in an order of source lines Scj, Saj+1, Sbj+2). The source line drive circuit 15 changes an order of display data included in the video signal V1 output from the display control circuit 13 in accordance with which one of the source lines 18 is connected to the pixel circuit 20, and applies voltages in accordance with the display data after changing the order, to the (m×p) source lines 18.

In the liquid crystal panel 61, among the first to third source lines, a resistance of the first source line is largest, a resistance of the second source line is second largest, and a resistance of the third source line is smallest. In the liquid crystal panel 61, the source line to which the pixel circuit 20 is connected is changed periodically in the row direction and the column direction among the first to third source lines. Therefore, according to the liquid crystal display device according to the present embodiment, by connecting the source lines 18 and the pixel circuits 20 as described above, it is possible to distribute an error in pixel brightness two-dimensionally and make brightness unevenness which occurs in the display screen difficult to recognize visually. Note that although the source line Saj is arranged on the left side in a furthest position from the pixel circuit 20 in the present embodiment, the source line Saj maybe arranged on a right side in a nearest position from the pixel circuit 20.

### Fourth Embodiment

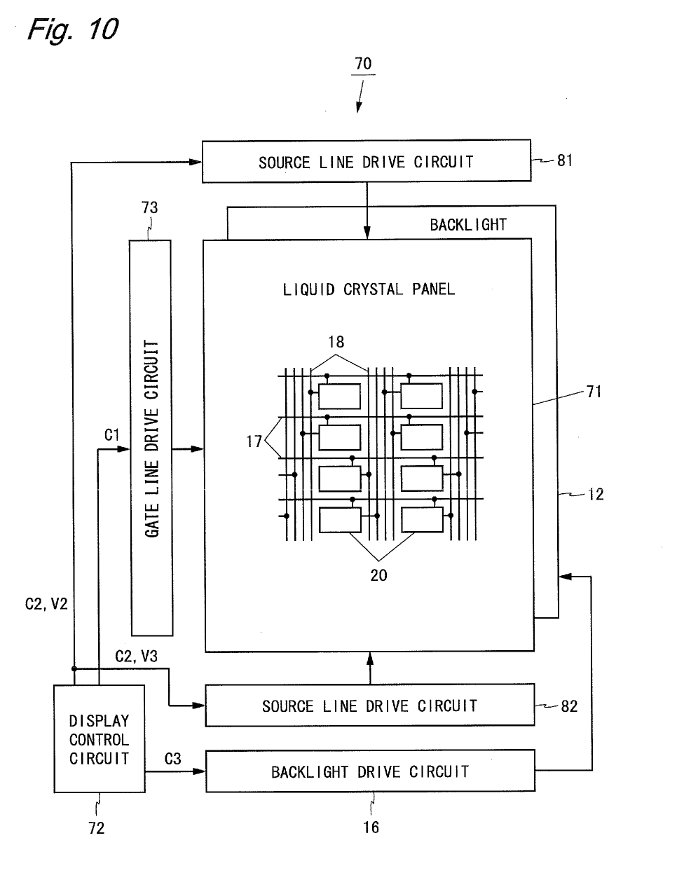

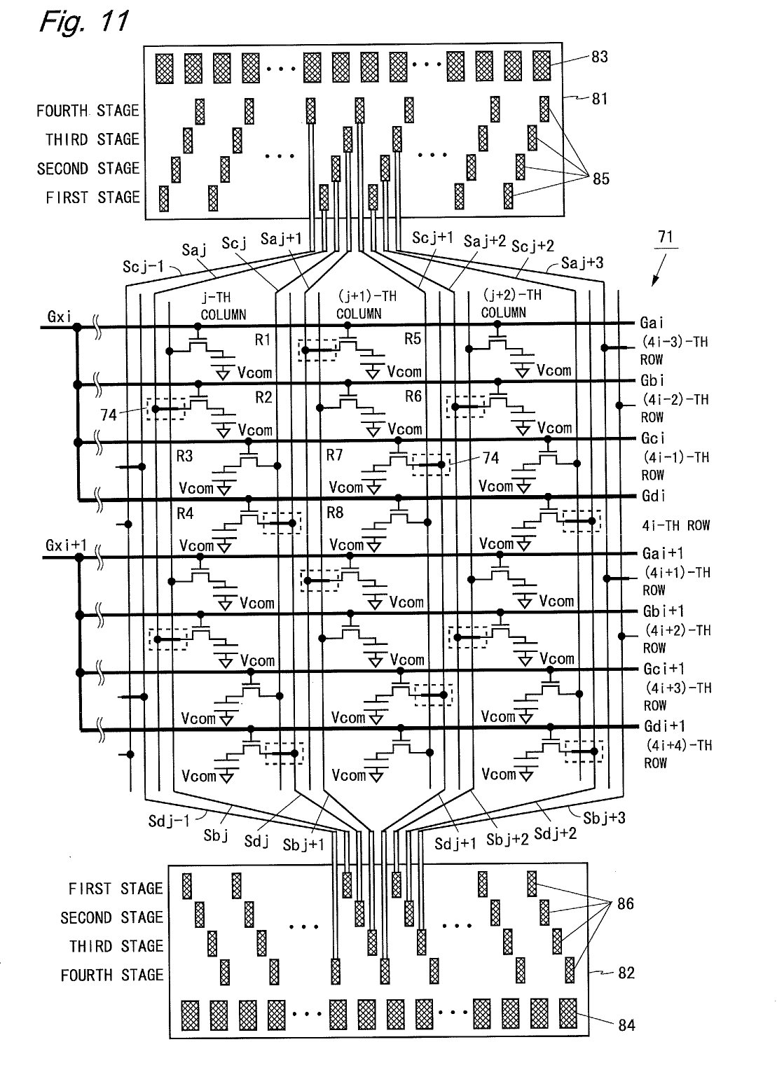

FIG. 10 is a block diagram showing a configuration of a liquid crystal display device according to a fourth embodiment. A liquid crystal display device 70 shown in FIG. 10 includes a liquid crystal panel 71, the backlight 12, a display control circuit 72, a gate line drive circuit 73, two source line drive circuits 81, 82, and the backlight drive circuit 16. It is assumed that p=4 in the present embodiment.

The source line drive circuit 81 is arranged along an upper side of the liquid crystal panel 71, and the source line drive circuit 82 is arranged along a lower side of the liquid crystal panel 71. The display control circuit 72 outputs the control signal C1 to the gate line drive circuit 73, outputs the control signal C2 and a video signal V2 to the source line drive circuit 81, outputs the control signal C2 and a video signal V3 to the source line drive circuit 82, and outputs the control signal C3 to the backlight drive circuit 16. The gate line drive circuit 73 drives the plurality of gate lines 17 based on the control signal C1. The source line drive circuit 81 drives odd-numbered source lines 18 from among the plurality of source lines 18 based on the control signal C2 and the video signal V2. The source line drive circuit 82 drives even-numbered source lines 18 from among the plurality of source lines 18 based on the control signal C2 and the video signal V3.

FIG. 11 is a diagram showing an equivalent circuit of the liquid crystal panel 71 and a connection form between the liquid crystal panel 71 and the source line drive circuits 81, 82. FIG. 11 describes twenty-four pixel circuits 20 arranged in (4i−3)-th to (4i+4)-th rows and j-th to (j+2)-th columns. The liquid crystal panel 71 has a repeating structure in which the pixel circuits 20 in four rows and two columns form a unit. Here, the pixel circuits 20 in the (4i−3)-th to 4i-th rows and the j-th column are referred to as R1 to R4, the pixel circuits 20 in the (4i−3)-th to 4i-th rows and the (j+1)-th column are referred to as R5 to R8, and the pixel circuits R1 to R8 and wirings connected to the pixel circuits R1 to R8 are described. Other portions of the liquid crystal panel 71 have a similar configuration.

Gate lines Gai to Gdi are respectively arranged on an upper side of the pixel circuits R1, R5, an upper side of the pixel circuits R2, R6, an upper side of the pixel circuits R3, R7, and an upper side of the pixel circuits R4, R8. Source lines Saj, Sbj are arranged on a left side of the pixel circuits R1 to R4, and source lines Scj, Sdj are arranged on a right side of the pixel circuits R1 to R4. Source lines Saj+1, Sbj+1 are arranged on a left side of the pixel circuits R5 to R8, and source lines Scj+1, Sdj+1 are arranged on a right side of the pixel circuits R5 to R8. The gate lines Gai to Gdi are classified into a same group, and one ends of the gate lines Gai to Gdi are connected to a same node. The node is connected to the i-th output terminal of the gate line drive circuit 73 using the wiring Gxi. Note that the gate line drive circuit 73 has (n/4) output terminals. One ends (upper ends in the drawings) of the odd-numbered source lines 18, such as the source lines Saj, Scj, are connected to the source line drive circuit 81. One ends (lower ends in the drawings) of the even-numbered source lines 18, such as the source lines Sbj, Sdj, are connected to the source line drive circuit 82.

The gate lines Gai to Gdi and the wiring Gxi are formed in the gate wiring layer integrally. The source lines Saj to Sdj, Saj+1 to Sdj+1 and the pixel electrodes 23 in the pixel circuits R1 to R8 are formed in the source wiring layer separately. The pixel circuits R1, R5 are connected to the gate line Gai, the pixel circuits R2, R6 are connected to the gate line Gbi, the pixel circuits R3, R7 are connected to the gate line Gci, and the pixel circuits R4, R8 are connected to the gate line Gdi. The pixel circuits R1 to R8 are connected to the source lines Sbj, Saj, Scj, Sdj, Saj+1, Sbj+1, Sdj+1, Scj+1, respectively.

The gate line Gai has branching portions corresponding to the pixel circuits R1, R5. Since no other gate line exists between the gate line Gai and the pixel circuits R1, R5, the gate line Gai and the pixel circuits R1, R5 can be connected easily by branching the gate line Gai. By a similar method, the gate line Gbi and the pixel circuits R2, R6 are connected, the gate line Gci and the pixel circuit R3, R7 are connected, and the gate line Gdi and the pixel circuits R4, R8 are connected.

The source line Sbj has a branching portion corresponding to the pixel circuit R1. Since no other source line exists between the source line Sbj and the pixel circuit R1, the source line Sbj and the pixel circuit R1 can be connected easily by branching the source line Sbj. By a similar method, the source line Scj and the pixel circuit R3 are connected, the source line Sbj+1 and the pixel circuit R6 are connected, and the source line Scj+1 and the pixel circuit R8 are connected.

The source line Sbj exists between the source line Saj and the pixel circuit R2. In order to connect the source line Saj and the pixel circuit R2 with avoiding the source line Sbj, a connection unit 74 having the same configuration as the connection unit 30 according to the first embodiment is provided to the liquid crystal panel 71. By a similar method, the source line Sdj and the pixel circuit R4 are connected, the source line Saj+1 and the pixel circuit R5 are connected, and the source line Sdj+1 and the pixel circuit R7 are connected.

In the liquid crystal panel 71, first and second source lines (source lines Saj, Sbj) are arranged on a first side (left side) of the pixel circuit 20 in a descending order of distance from the pixel circuit 20, and third and fourth source lines (source lines Scj, Sdj) are arranged on a second side (right side) of the pixel circuit 20 in an ascending order of distance from the pixel circuit 20. Each of a part of the connection units 74 connects the first source line and the pixel circuit 20 with avoiding the second source line. Each of remaining connection units 74 connects the fourth source line and the pixel circuit 20 with avoiding the third source line. The pixel circuits 20 in a same row are alternately connected to the first and second source lines, or are alternately connected to the third and fourth source lines. The source line to which the pixel circuits 20 in a same column are connected is changed periodically among the first to fourth source lines (is changed in an order of source lines Sbj, Saj, Scj, Sdj). The source line drive circuits 81, 82 change an order of the display data included in the video signals V2, V3 output from the display control circuit 72 in accordance with which one of the source lines 18 is connected to the pixel circuit 20, and applies voltages in accordance with the display data after changing the order, to (m×p/2) source lines.

An IC chip including the source line drive circuit 81 has a plurality of input terminals 83 and 2m output terminals 85. The 2m output terminals 85 are arranged in a four-stage staggered manner. The output terminals 85 connected to the source lines Saj, Saj+2, and the like are arranged in a first stage of a staggered array. The output terminals 85 connected to the source lines Scj, Scj+2, and the like are arranged in a second stage of the staggered array. The output terminals 85 connected to the source lines Saj+1, Saj+3, and the like are arranged in a third stage of the staggered array. The output terminals 85 connected to the source lines Scj+1, Scj+3, and the like are arranged in a fourth stage of the staggered array.

An IC chip including the source line drive circuit 82 has a plurality of input terminals 84 and 2m output terminals 86. The 2m output terminals 86 are arranged in a four-stage staggered manner. The output terminals 86 connected to the source lines Sbj, Sbj+2, and the like are arranged in a first stage of a staggered array. The output terminals 86 connected to the source lines Sdj, Sdj+2, and the like are arranged in a second stage of the staggered array. The output terminals 86 connected to the source lines Sbj+1, Sbj+3, and the like are arranged in a third stage of the staggered array. The output terminals 86 connected to the source lines Sdj+1, Sdj+3, and the like are arranged in a fourth stage of the staggered array. IC chips having a same specification may be used as the source line drive circuits 81, 82.

According to the liquid crystal display device 70 according to the present embodiment, a low-cost liquid crystal display device having a short screen update time can be provided.

As for the above-described liquid crystal display devices, a variety of variants can be configured. For example, in a liquid crystal display device according to a variant, p (first number) may be an arbitrary integer equal to or larger than two. If the first number is equal to a sum of a second number and a third number, a second number of source lines may be arranged on a first side (left side, for example) of the pixel circuit 20, and a third number of source line(s) maybe arranged on a second side (right side, for example) of the pixel circuit 20. A connection unit connects the source line and the pixel circuit 20 with avoiding another source line arranged between the source line and the pixel circuit 20. Especially, the pixel circuits 20 in a same row may be connected to one of the first number of source lines, and the source line to which the pixel circuits 20 in a same column are connected may be changed periodically among the first number of source lines. A width of the source line may be wider as a distance from the pixel circuit 20 to which the source line is connected is longer. The first embodiment describes a case where the second number is two and the third number is one. Alternatively, the source line to which the pixel circuits 20 in a same row are connected may be changed periodically among the second number of source lines, or may be changed periodically among the third number of source lines, and the source line to which the pixel circuits in a same column are connected may be changed periodically among the first number of source lines. The fourth embodiment describes a case where the second number and the third number are two.

Alternatively, the first number of source lines may be arranged on one side (for example, left side) of the pixel circuit 20. The connection unit connects the source line and the pixel circuit 20 with avoiding another source line arranged between the source line and the pixel circuit 20. Especially, the source line to which the pixel circuits 20 in a same row are connected may be changed periodically among the first number of source lines, and the source line to which the pixel circuits 20 in a same column are connected may be changed periodically among the first number of source lines. The third embodiment describes a case where the first number is three.

Furthermore, in the above-described liquid crystal display devices, the source line 18 is arranged between neighboring pixel circuits 20. In this case, a black metal may be provided so as to cover the source line 18 to shield the source line 18 from light. Alternatively, the source line 18 may be arranged in a lower layer of the pixel circuit 20. Furthermore, an active matrix type display device other than the active matrix type liquid crystal display device may be configured by a method similar to the above-described method.

Although the present invention is described in detail in the above, the above description is exemplary in all of the aspects and is not restrictive. It is understood that various other changes and modification can be derived without going out of the prevent invention.

This application claims a priority based on Japanese Patent Application No. 2018-4663 filed on Jan. 16, 2018, and entitled “Active Matrix Type Display Device”, which is incorporated herein by reference in its entirety.

What is claimed is:

1. An active matrix type display device comprising:
a display panel including a plurality of gate lines extending in a row direction, a plurality of source lines extending in a column direction, and a plurality of pixel circuits arranged in the row direction and the column direction;
a gate line drive circuit configured to drive the gate lines; and
a source line drive circuit configured to drive the source lines, wherein
the source lines are provided so that a first number of source lines correspond to each column of the pixel circuits, the first number being equal to or larger than two,
the gate line drive circuit is configured to select a first number of gate lines in a same period, and
the display panel has a connection unit including a first connection wiring formed in a same wiring layer as the gate line, having a first end connected to the source line, and extending in the row direction to intersect with another source line in a planar view, and a second connection wiring formed in a same wiring layer as the source line, and connected to a second end of the first connection wiring, at each of a part of connection positions between the source lines and the pixel circuits.

2. The display device according to claim 1, wherein the connection unit includes a first contact hole configured to connect the source line and the first end of the first connection wiring, and a second contact hole configured to connect the second end of the first connection wiring and the second connection wiring.

3. The display device according to claim 2, wherein
the second connection wiring is configured to extend in the row direction, and
the second contact hole is configured to connect the second end of the first connection wiring and a first end of the second connection wiring.

4. The display device according to claim 3, wherein
the pixel circuit includes a write control transistor, and
a second end of the second connection wiring functions as one conduction terminal of the write control transistor.

5. The display device according to claim 4, wherein
one ends of the first number of gate lines are connected to a same node, and
the gate line drive circuit is configured to apply a voltage to the node.

6. The display device according to claim 1, wherein
the source line drive circuit includes:
a first number of line memories; and
a first number of output circuits having a same configuration and configured to operate in parallel.

7. The display device according to claim 6, wherein output terminals of the source line drive circuit are arranged in a staggered manner in a first number of stages.

8. The display device according to claim 1, wherein
the first number is three,
first and second source lines are arranged on a first side of the pixel circuit in a descending order of distance from the pixel circuit, and a third source line is arranged on a second side of the pixel circuit, and
the connection unit is configured to connect the pixel circuit and the first source line with avoiding the second source line.

9. The display device according to claim 8, wherein
the pixel circuits in a same row is connected to one of the first to third source lines, and
the source line to which the pixel circuits in a same column are connected is changed periodically among the first to third source lines.

10. The display device according to claim 8, wherein a line width of the first source line is wider than line widths of the second and third source lines.

11. The display device according to claim 1, wherein
the first number is three,
first, second, and third source lines are arranged on a first side of the pixel circuit in a descending order of distance from the pixel circuit, and
each of a part of the connection units is configured to connect the second source line and the pixel circuit with avoiding the third source line, and each of remaining connection units is configured to connect the first source line and the pixel circuit with avoiding the second and third source lines.

12. The display device according to claim 11, wherein
the source line to which the pixel circuits in a same row are connected is changed periodically among the first to third source lines, and
the source line to which the pixel circuits in a same column are connected is changed periodically among the first to third source lines.

13. The display device according to claim 1, wherein
the first number is four,
first and second source lines are arranged on a first side of the pixel circuit in a descending order of distance from the pixel circuit, and third and fourth source lines are arranged on a second side of the pixel circuit in an ascending order of distance from the pixel circuit, and
each of a part of the connection units is configured to connect the first source line and the pixel circuit with avoiding the second source line, and each of remaining connection units is configured to connect the fourth source line and the pixel circuit with avoiding the third source line.

14. The display device according to claim 13, wherein
the pixel circuits in a same row are alternately connected to the first and second source lines, or are alternately connected to the third and fourth source lines, and
the source line to which the pixel circuits in a same column are connected is changed periodically among the first to fourth source lines.

15. The display device according to claim 1, wherein
the first number is a sum of a second number and a third number,
a second number of source lines are arranged on a first side of the pixel circuit, and a third number of source lines are arranged on a second side of the pixel circuit, and
the connection unit is configured to connect the source line and the pixel circuit with avoiding another source line arranged between the source line and the pixel circuit.

16. The display device according to claim 15, wherein
the pixel circuits in a same row are connected to one of the first number of source lines, and
the source line to which the pixel circuits in a same column are connected is changed periodically among the first number of source lines.

17. The display device according to claim 15, wherein a width of the source line is wider as a distance from the pixel circuit to which the source line is connected is longer.

18. The display device according to claim 15, wherein
the source line to which the pixel circuits in a same row are connected is changed periodically among the second number of source lines, or is changed periodically among the third number of source lines, and
the source line to which the pixel circuits in a same column are connected is changed periodically among the first number of source lines.

19. The display device according to claim 1, wherein
the first number of source lines are arranged on one side of the pixel circuit, and
the connection unit is configured to connect the source line and the pixel circuit with avoiding another source line arranged between the source line and the pixel circuit.

20. The display device according to claim 19, wherein
the source line to which the pixel circuits in a same row are connected is changed periodically among the first number of source lines, and
the source line to which the pixel circuits in a same column are connected is changed periodically among the first number of source lines.
